(19) United States
(12) Patent Application Publication
(10) Pub. No.: US 2025/0158484 A1
(43) Pub. Date: May 15, 2025

(54) CONTROL SYSTEM FOR A MAGNETIC BEARING AND ASSOCIATED METHOD

(71) Applicant: SKF Magnetic Mechatronics, Saint-Marcel (FR)

(72) Inventors: Lakdar SADI-HADDAD, Nogent sur Marne (FR); Sylvain PALMERI, Angerville la campagne (FR)

(21) Appl. No.: 18/938,388

(22) Filed: Nov. 6, 2024

(30) Foreign Application Priority Data
Nov. 14, 2023 (FR) 2312416

(51) Int. Cl. H02K 7/09; H04B 3/54

(52) U.S. Cl. CPC H02K 7/09; H04B 3/542

(57) ABSTRACT

A control system (1) for a magnetic bearing (3, 4). The control system (1) comprises a control loop (BR1) for the magnetic bearing. The control loop comprises a master control node (5) and at least two slave control nodes (6, 7). The slave control nodes (6, 7,) are connected in series by a first bidirectional data bus (8) of said system. A second bidirectional data bus (9) connects the control nodes (6, 7) situated at the ends of the control loop to one another. The master control node comprises transmitting means (10).

### CROSS-REFERENCE TO RELATED APPLICATION

This application claims priority to French Application No. 2312416, filed Nov. 14, 2023, the entirety of which is hereby incorporated by reference.

### FIELD

The present disclosure relates to the control of magnetic bearings.

The present disclosure relates more particularly to a control system for a magnetic bearing comprising control nodes and a method for controlling the magnetic bearing.

### BACKGROUND

A control system for a magnetic bearing may be based on a distributed architecture comprising a “master” control module and “slave” control modules connected to the “master” control module by data buses in order to form a control loop for the magnetic bearing clocked by the “master” control module.

Each “slave” control node independently controls a power converter controlling a different servocontrol axis of the bearing, notably on the basis of data generated by sensors of the magnetic bearing.

A first data bus connects the “master” control module and the “slave” control modules to one another in series, and a second data bus connects the “master” control module to the “slave” control module situated at the end of the control loop.

However, when a bus is faulty, for example when the wires of the bus are cut between two adjacent slave control nodes, the data passing over said bus are no longer routed to all of the slave control nodes, causing, for example, a desynchronization of the slave control nodes which is liable to impair the operation of the magnetic bearing.

It is therefore proposed to mitigate all or some of these drawbacks by improving the reliability of the control system for a magnetic bearing.

### SUMMARY

In light of the above, the present disclosure proposes a method for controlling a magnetic bearing by means of a control loop comprising a first bidirectional data bus, connecting a master control node and at least two slave control nodes in series, and a second bidirectional data bus connecting said control nodes, which are situated at the ends of the control loop, to one another, each slave control node controlling a different servocontrol axis of the magnetic bearing.

The method comprises:
the master control node transmitting a first data frame through the first data bus; and
the master control node transmitting a second data frame through the second data bus, the first frame and the second frame being identical.

What is meant by “servocontrol axis of the bearing” is the axis which is defined by two diametrically opposite coils of the stator of the magnetic bearing.

Despite the failure of either the first or the second bidirectional data bus, the magnetic bearing is controlled by the control loop.

Preferably, each data frame comprises as many predetermined locations as slave and master control nodes, each predetermined location being associated with a slave or master control node so that each slave or master control node knows the address of the predetermined location associated with said node, each frame comprising a sequence of bits, transmitting the first frame comprising sequentially transmitting the bits of said frame and transmitting the second frame comprising sequentially transmitting the bits of said frame.

Advantageously, the method further comprises, for each slave and master node, writing data of said node to the bits associated with the predetermined location of said node in the first frame and the second frame.

Preferably, each data frame comprises servocontrol data of the slave control nodes.

Advantageously, the first data bus and the second data bus are synchronous buses.

Also proposed is a control system for a magnetic bearing comprising a control loop for the magnetic bearing, the control loop comprising a master control node and at least two slave control nodes, connected in series by a first bidirectional data bus of said system, and a second bidirectional data bus connecting the control nodes, which are situated at the ends of the control loop, to one another.

The master control node comprises transmitting means configured to:
transmit a first data frame through the first data bus, and
transmit a second data frame through the second data bus.

Advantageously, each data frame comprises as many predetermined locations as slave and master control nodes, each predetermined location being associated with a slave or master control node so that each slave or master control node knows the address of the predetermined location associated with said node, each frame comprising a sequence of bits, the transmitting means being configured to sequentially transmit the bits of the first frame through the first data bus and to sequentially transmit the bits of the second frame through the first data bus.

Preferably, each slave and master control node comprises writing means configured to write data of said node to the bits associated with the predetermined location of said node in the first frame and the second frame.

Advantageously, the master control node comprises a slave control node.

Preferably, each slave control node is configured to control said magnetic bearing independently of other slave control nodes.

### BRIEF DESCRIPTION OF THE FIGURES

Other aims, features and advantages of the present disclosure will become apparent from reading the following description, which is given purely by way of non-limiting example and with reference to the appended drawings, in which:

FIG. 1 illustrates one example of a distributed control system for a magnetic bearing according to the present disclosure; and

FIG. 2 illustrates one example of an implementation of the control system for a magnetic bearing after a failure is detected according to the present disclosure.

### DETAILED DESCRIPTION

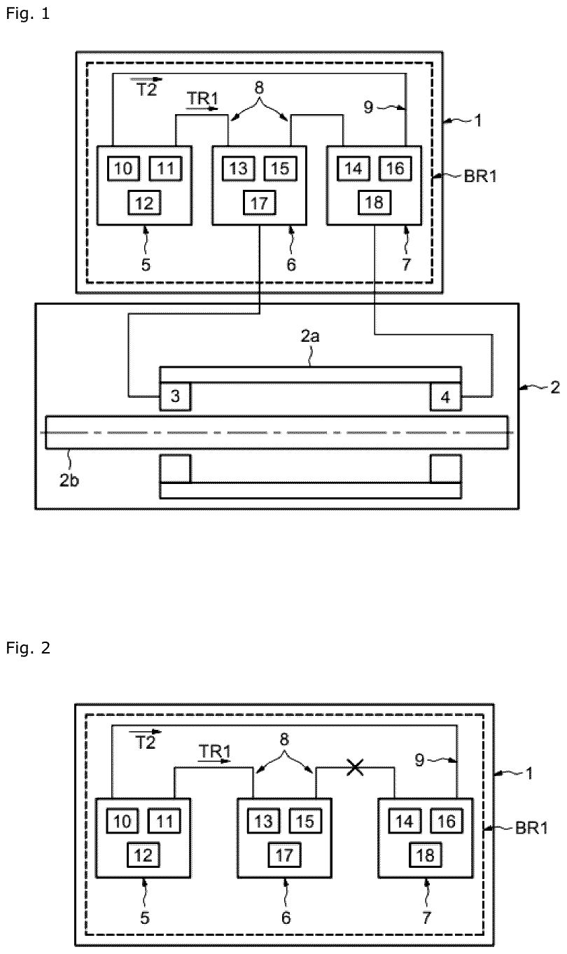

Reference is made to FIG. 1, which illustrates one example of a control system 1 for a magnetic bearing controlling a device 2 comprising magnetic bearings.

In a manner known per se, the device 2 comprises a stator 2a and a rotor 2b which is placed in the stator 2a.

The stator 2a comprises two magnetic bearings 3, 4 arranged at the ends of the stator 2a.

Each magnetic bearing 3, 4 comprises coils distributed uniformly in the circumferential direction of the inner side of the stator 2a, two diametrically opposite coils being connected to one another so as to be supplied with power simultaneously by an electric power converter.

Two diametrically opposite stator coils define a servocontrol axis of the magnetic bearing and make it possible to control this axis.

The distributed control system 1 comprises a control loop BR1 comprising a master control node 5, a first slave control node 6 connected to the master control node 5 and a second slave control node 7 connected to the first slave control node 5.

The master control node 5 may, for example, be situated at one end of the control loop BR1.

Alternatively, the master control node 5 may be situated elsewhere in the control loop BR1.

The master control node 5 may comprise a slave control node.

The master control node 5 and the slave control nodes 6, 7 are connected to one another by a first bidirectional data bus 8.

A second bidirectional data bus 9 connects the master control node 5 and the second slave control node 7.

The slave control nodes 6, 7 are clocked by the master control node 5.

The first data bus 8 and the second data bus 9 form a communication ring.

The first data bus 8 and the second data bus 9 are, for example, synchronous buses.

The master control node 5 comprises transmitting means 10, writing means 11 and reading means 12.

Each slave control node 6, 7 is connected to the first data bus 6 and to the second data bus 7.

The first slave control node 6 is able to control a first magnetic bearing 3 and the second slave control node 7 is able to control the second magnetic bearing 3.

The first slave control node 6 is connected to the coils of the first magnetic bearing 3 and the second slave control node 7 is connected to the coils of the second magnetic bearing 3.

Each slave control node 6, 7 comprises reading means 13, 14, writing means 15, 16 and transmitting means 17, 18.

Of course, the system 1 may comprise more than two slave control nodes for controlling the device 2. It is enough to add one additional slave control node per magnetic bearing, the additional node being connected to an adjacent node in series.

When neither the first data bus 8 nor the second data bus 9 is faulty, the transmitting means 10 of the master control node 5 transmit a first data frame TR1 through the first data bus 8 and a second data frame TR2 through the second data bus 9, the first frame TR1 and the second frame TR2 being identical.

The first frame TR1 and the second frame TR2 are transmitted simultaneously or consecutively.

Each frame TR1, TR2 comprises a sequence of bits which are transmitted sequentially by the transmitting means 10.

Each data frame TR1, TR2 comprises as many predetermined locations as slave control nodes 6, 7 and master node 5.

Each predetermined location is associated with a slave control node 6, 7 so that each slave control node 6, 7 knows the address of the predetermined location associated with said node 6, 7.

In this instance, each frame TR1, TR2 comprises three locations.

It is assumed that a first location of each frame TR1, TR2 is intended to contain data of the master node 5, a second location of each frame TR1, TR2 is intended to contain data of the first slave control node 6 and a third location of each frame TR1, TR2 is intended to contain data of the second slave control node 7.

The data of the slave control nodes 6, 7 comprise servocontrol data of said nodes.

When each frame TR1, TR2 is transmitted, the writing means 11 of the master node 5 write the data of the master node 5 to the first location of each frame TR1, TR2.

When the first slave control node 6 receives the first frame TR1, the reading means 13 of the first slave control node 6 may read the data of the master node 5 which are stored in the first location of the first frame TR1 and the writing means 15 of the first slave control node 6 write the data of the first slave control node 6 to the second location of the first frame TR1.

When the second location of the first frame TR1 is filled, the transmitting means 17 of the first slave control node 6 transmit the first frame TR1 through the first bus 8.

When the second slave control node 7 receives the first frame TR1, the reading means 14 of the second slave control node 7 may read the data of the master node 5 and the data of the first slave control node 6 which are stored in the first location and the second location of the first frame TR1 and the writing means 16 of the second slave control node 7 write the data of the second slave control node 7 to the third location of the first frame TR1.

When the third location of the first frame TR1 is filled, the transmitting means 18 of the second slave control node 7 transmit the first frame TR1 through the second bus 9.

The first frame TR1 comprising the three locations storing the data of the nodes 5, 6, 7 is received by the master node 5 and read by the reading means 12 of the master control node 5.

When the second slave control node 7 receives the second frame TR2, the reading means 14 of the second slave control node 7 may read the data of the master node 5 which are stored in the first location of the second frame TR2 and the writing means 15 of the second slave control node 7 write the data of the second slave control node 7 to the third location of the second frame TR2.

When the third location of the second frame TR2 is filled, the transmitting means 18 of the second slave control node 7 transmit the second frame TR2 through the first bus 8.

When the first slave control node 6 receives the second frame TR2, the reading means 13 of the first slave control node 8 may read the data of the master node 5 and the data of the second slave control node 7 which are stored in the first location and the third location of the second frame TR2 and the writing means 15 of the first slave control node 6 write the data of the first slave control node 6 to the second location of the second frame TR2.

When the second location of the second frame TR2 is filled, the transmitting means 17 of the second slave control node 6 transmit the second frame TR2 through the first bus 8.

The second frame TR2 comprising the three locations filled by the nodes 5, 6, 7 is received by the master node 5.

The two frames TR1, TR2 received by each node 5, 6, 7 make it possible to share all of the data of said nodes with each node of the system 1 quickly.

FIG. 2 illustrates one example of an implementation of the system 1 after a failure of one of the data buses 8, 9 is detected.

It is assumed that the wires of the first bus 6 are cut (shown by a cross) between the first slave control node 6 and the second slave control node 7.

The first frame TR1 filled by the writing means 11 of the master control node 5 and transmitted by the means 10 of said node is received by the first slave control node 6.

The reading means 13 of the first slave control node 6 may read the data of the master node 5 which are stored in the first location of the first frame TR1 and the writing means 15 of the first slave control node 6 write the data of the first slave control node 6 to the second location of the first frame TR1.

The transmitting means 17 of the first slave control node 6 transmit the filled first frame TR1 over the first bus 8.

Since the first bus 8 is cut between the first slave control node 6 and the second slave control node 7, the filled first frame TR1 is received by the master control node 5, read by the reading means 12 of the master control node 5 and transmitted by the transmitting means 10 of the master control node 5 over the second bus 9.

The reading means 14 of the second slave control node 7 may read the data of the first slave control node 6 and of the master control node 5.

The second frame TR2 filled by the writing means 11 of the master control node 5 and transmitted by the means 10 of said node is received by the second slave control node 7.

The reading means 14 of the second slave control node 7 may read the data of the master node 5 which are stored in the first location of the second frame TR2 and the writing means 16 of the second slave control node 7 write the data of the second slave control node 7 to the third location of the second frame TR2.

Since the first bus 8 is cut between the first slave control node 6 and the second slave control node 7, the transmitting means 18 of the second slave control node 7 transmit the filled second frame TR2 over the second bus 9.

The filled second frame TR2 is received by the master control node 5, read by the reading means 12 of the master control node 5 and transmitted over the first bus 8.

The reading means 13 of the first slave control node 6 may read the data of the second slave control node 7 and of the master control node 5.

The master control node 5 and the first slave control node 6 and the second slave control node 7 receive all of the data transmitted by the control loop BR1 despite the failure of the first bus 8, so that the master control node 5 and the slave control nodes 6, 7 all control the magnetic bearing.

Despite the failure of the control loop BR1, the magnetic bearings 3, 4 continue to operate.

The first frame TR1 and the second frame TR2 are transmitted simultaneously or consecutively.

What is claimed is:

1. A method for controlling a magnetic bearing, the method comprising:
providing a control loop comprising a first bidirectional data bus, a second bidirectional data bus, a master control node, and at least two slave control nodes, the first bidirectional data bus connecting the master control node and the at least two slave control nodes in series, the second bidirectional data bus connecting two control nodes of the master control node and the at least two slave control nodes situated at each end of the control loop to one another, each slave control node controlling a different servocontrol axis of the magnetic bearing;
the master control node transmitting a first data frame through the first data bus; and
the master control node transmitting a second data frame through the second data bus, the first frame and the second frame being identical.

2. The method according to claim 1, wherein each data frame comprises as many predetermined locations as slave and master control nodes, each predetermined location being associated with a slave or master control node so that each slave or master control node knows the address of the predetermined location associated with said node, each frame comprising a sequence of bits, transmitting the first frame comprising sequentially transmitting the bits of said frame and transmitting the second frame comprising sequentially transmitting the bits of said frame.

3. The method according to claim 2, further comprising, for each slave and master control node, writing data of said node to the bits associated with the predetermined location of said node in the first frame and the second frame.

4. The method according to claim 1, wherein each data frame comprises servocontrol data of the slave control nodes.

5. The method according to claim 1, wherein the first data bus and the second data bus are synchronous buses.

6. The method according to claim 3, wherein each data frame comprises servocontrol data of the slave control nodes.

7. The method according to claim 6, wherein the first data bus and the second data bus are synchronous buses.

8. A control system for a magnetic bearing, the control system comprising:
a control loop for the magnetic bearing, the control loop comprising a master control node and at least two slave control nodes, the control loop comprising a first bidirectional data bus connecting the master control node and the at least two slave control nodes in series, the control loop comprising a second bidirectional data bus connecting two control nodes of the master control node and the at least two slave control nodes situated at each end of the control loop to one another, the master control node comprising a transmitting means configured to transmit a first data frame through the first data bus, and transmit a second data frame through the second data bus.

9. The control system according to claim 8, wherein each data frame comprises as many predetermined locations as slave and master control nodes, each predetermined location being associated with a slave or master control node so that each slave or master control node knows the address of the predetermined location associated with said node, each frame comprising a sequence of bits, the transmitting means being configured to sequentially transmit the bits of the first frame through the first data bus and to sequentially transmit the bits of the second frame through the first data bus.

10. The control system according to claim 9, wherein each slave and master control node comprises writing means configured to write data of said node to the bits associated with the predetermined location of said node in the first frame and the second frame.

11. The control system according to claim 8, wherein the master control node comprises a slave control node.

12. The control system according to claim 8, wherein each slave control node is configured to control said magnetic bearing independently of other slave control nodes.

13. The control system according to claim 10, wherein the master control node comprises a slave control node.

14. The control system according to claim 13, wherein each slave control node is configured to control said magnetic bearing independently of other slave control nodes.
